(19) United States
(12) Patent Application Publication
(10) Pub. No.: US 2014/0224214 A1
(43) Pub. Date: Aug. 14, 2014

(54) INJECTION VALVE FOR INTERNAL COMBUSTION ENGINES

(71) Applicant: Marco Vorbach, Freiberg (DE)

(72) Inventor: Marco Vorbach, Freiberg (DE)

(21) Appl. No.: 14/124,902

(22) PCT Filed: Apr. 24, 2012
(86) PCT No.: PCT/EP2012/057466

§ 371 Date: Mar. 25, 2014

(30) Foreign Application Priority Data
Jun. 9, 2011 (DE) 10 2011 077 268.5

(51) Int. Cl. F02M 69/04

(52) U.S. Cl. CPC F02M 69/04
USPC 123/445

(57) ABSTRACT

An injection valve is indicated for internal combustion engines, having a sealing seat formed by a valve seat and a closing head of a valve needle, and having a plurality of spray holes situated downstream from the sealing seat. The spray holes, which are stepped in cross-section, each have at least one upstream hole inlet section having a very small hole cross-section and a hole inlet opening, and a downstream hole outlet section having a very large hole cross-section and a hole outlet opening. In order to prevent unwanted deposition of burnt fuel on the edges of the hole outlet openings, all the hole outlet sections are connected to one another by a groove having a groove opening that points downstream.

### FIELD OF THE INVENTION

The present invention is based on an injection valve for internal combustion engines.

### BACKGROUND INFORMATION

A known fuel injection valve for internal combustion engines, described in German Published Patent Application No. 10 2005 036 951 and realized as a so-called multi-hole injection valve, has a valve seat element that terminates a hollow cylindrical valve seat bearer and that limits a valve chamber that stands in connection with a fuel supply line. In the valve seating element, there are fashioned a valve seat in the form of an annular surface concentrically surrounding the axis of the valve seat element, and a large number of spray holes. Together with a closing element of a valve member disposed so as to be axially displaceable in the valve seat bearer, the valve seat forms a sealing seat that terminates the spray holes. The valve member is acted on by a valve closing spring that presses the closing head onto the valve seat. An electromagnetic actuator that acts on the valve member is capable of lifting the closing head more or less far away from the valve seat, against the return force of the valve closing spring. Each of the large number of spray holes has a hole inlet section, situated upstream and having a small cross-section, that has a hole inlet opening, and a hole outlet section, situated downstream and having a larger cross-section, that has a hole outlet opening. The hole inlet openings of all the spray holes are situated within the annular surface that forms the valve seat on the valve element, and the hole outlet openings of all the spray holes are situated in the convex outer wall, facing away from the valve chamber, of the valve seat element.

In such an injection valve, having spray holes in the valve seat element that are stepped in cross-section and that have an enlargement of their cross-section in the downstream direction, the tendency toward formation of deposits of burnt fuel and coking, and thus the danger of clogging of the open cross-section of the spray holes, is reduced. However, it has turned out that the flow exiting from the spray holes at the end of the injection produces a vacuum region in its wake, due to its inertia, and this vacuum draws the fuel film that builds up on the wall of the hole outlet openings during injection in the direction of the outlet edge of the hole outlet openings. Here, on the one hand the adhering fuel lamellae are converted into deposits by the engine combustion, and on the other hand non-adhering fuel lamellae are carried into the combustion chamber. Due to the poor preparation quality, the latter do not participate adequately in the combustion, causing an increase in soot emissions.

### SUMMARY

The injection valve according to the present invention has the advantage that air can flow from outside into the hole outlet sections via the groove that connects all the hole outlet sections of the spray holes, so that adequate ventilation is provided and the pressure conditions in the hole outlet sections are thus positively modified. In the valve closing phase, the exiting wake flow then no longer produces a vacuum that would draw the fuel film, built up during the injection phase on the wall surfaces of the hole outlet sections, in the direction of the hole outlet openings. The exiting of the fuel film from the hole outlet openings is prevented, and the deposits arising due to the engine combustion do not occur at the hole outlet openings—which are critical for nebulization—but rather inside the hole outlet sections, and are therefore no longer relevant to the exhaust gas. In this way, the soot emission of the internal combustion engine can be kept largely constant over its useful life, and the increase in soot emission in the exhaust gas that previously went along with the aging of the engine is avoided.

According to an advantageous specific embodiment of the present invention, the width of the groove is smaller than the diameter of the hole outlet openings. In this way, in the hole outlet sections a turbulence is achieved of the air flowing in from outside, which ensures a very good ventilation of the hole outlet sections.

According to an advantageous specific embodiment of the present invention, the hole outlet openings are situated on a divider circle, and the groove that connects the hole outlet openings is made in a circular annular shape.

### BRIEF DESCRIPTION OF THE DRAWINGS

FIG. 1 shows a segment of a longitudinal section of an injection valve for an internal combustion engine.

FIG. 2 shows a view from below of the injection valve of FIG. 1.

FIG. 3 shows a segment of a top view according to arrow III in FIG. 1.

FIG. 4 shows a section along the line IV-IV in FIG. 3.

### DETAILED DESCRIPTION

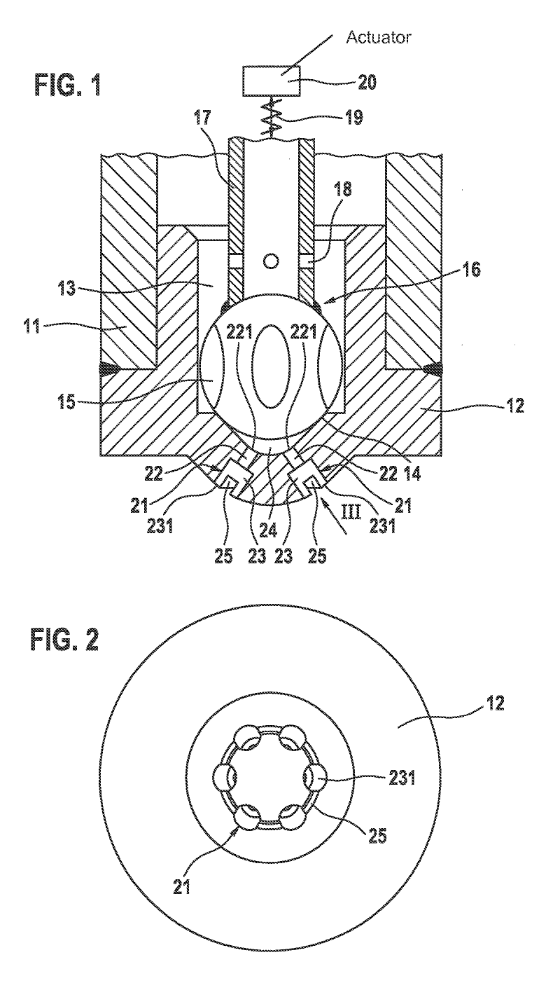

The injection valve of which a part is shown schematically in FIG. 1, with its injecting end shown in longitudinal section, for injecting fuel into a combustion cylinder of an internal combustion engine has a sleeve-type valve seat bearer 11 that extends from a valve housing (not shown here) and is terminated at its free end by a valve seat element 12. On the inner wall, limiting a valve chamber 13, of valve seat element 12 there is fashioned a valve seat 14 in the form of an annular surface that is concentric to the axis of valve seat element 12, and that, together with a closing head 15 of a valve member 16 situated so as to be axially displaceable in valve seat bearer 12, forms a so-called sealing seat. Closing head 15 is fastened, e.g. welded, to the frontal end of a hollow cylindrical valve needle 17 of valve member 16. Valve needle 17 has radial bores 18 and is connected to a fuel supply line (not shown here) that is fashioned in the valve housing, so that fuel moves from the fuel supply line via valve needle 17 and radial bores 18 into valve chamber 13, and there stands against the sealing seat under pressure. A valve closing spring 19 and an actuator 20, schematically indicated in FIG. 1, act on valve member 16 in a known manner. Actuator 20 is e.g. an electromagnet. Valve closing spring 19 presses closing head 15 onto valve seat 14. Electromagnetic actuator 20 lifts closing head 15 more or less far from valve seat 14, against the return force of valve closing spring 19.

Downstream from the sealing seat, in valve seat element 12 there are situated spray holes 21 that each have at least two hole sections that are stepped in cross-section, namely an upstream hole inlet section 22 having a very small hole cross-section and a hole inlet opening 221, and a downstream hole outlet section 23 having a very large hole cross-section and a hole outlet opening 231. Between upstream hole inlet section 22 having the very small hole cross-section and downstream hole outlet section 23 having the very large hole cross-section, further stepped hole sections having increasing cross-section may be present. All hole inlet openings 221 on the one hand and all hole outlet openings 231 on the other hand lie on a divider circle in planes parallel to one another that extend transverse to the axis of valve seating element 12. Hole inlet openings 221 of hole inlet sections 22 are situated in the inner wall, limiting valve chamber 13, of valve seat element 12, in a central zone, enclosed by valve seat 14 fashioned as an annular surface, of the inner wall of valve seat element 12, and hole outlet openings 231 of hole outlet sections 23 are situated in the outer wall, facing away from valve chamber 13, of valve seat element 12, in a central area, here fashioned with a calotte shape, of valve seat element 12. In the depicted exemplary embodiment, a trough-shaped recess 24 is formed in the central zone, enclosed by valve seat 14, of the inner wall of valve seat element 12, and hole inlet openings 221 are situated in this recess. Spray holes 21 are oriented in valve seat element 12 in such a way that their hole axes are inclined at an acute angle to the axis of valve seat element 12.

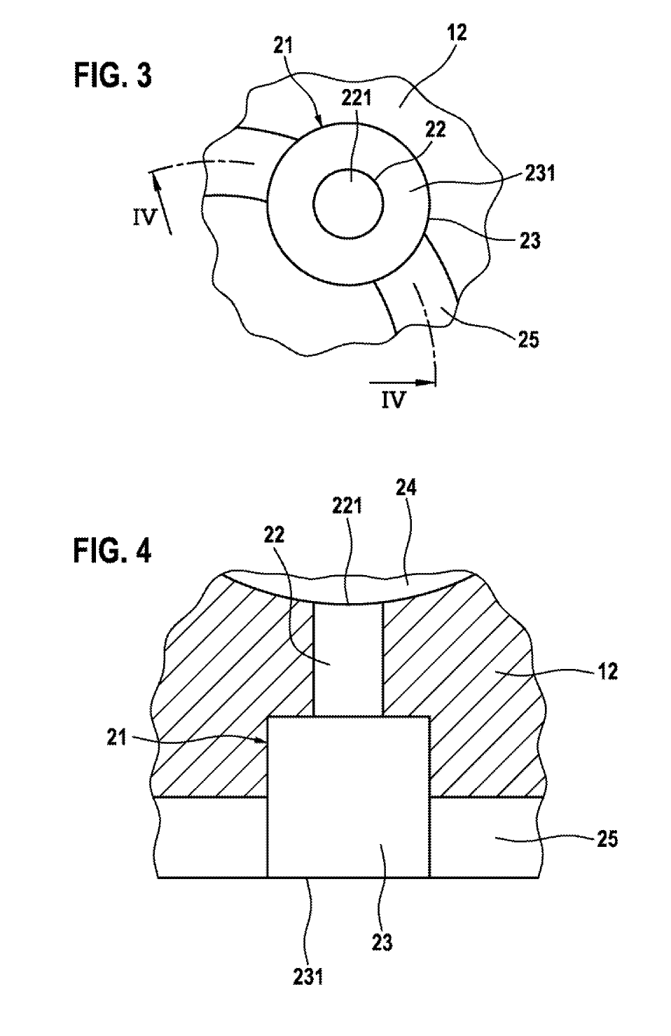

In order to prevent burnt fuel from depositing around the edges of hole outlet openings 231, and thus in order to counteract an increase over the long term of soot emissions in the exhaust gas, in the outer wall, facing away from valve chamber 13, of valve seat element 12 there is made a groove 25 in such a way that its downstream-pointing groove opening runs through all hole outlet sections 23, and thus connects all hole outlet sections 23 of spray holes 21 with one another. For this purpose, groove 25 has a circular annular shape. The width of the groove is smaller than the diameter of hole outlet openings 231. In FIGS. 3 and 4, for a spray hole 21 in valve seat element 12, groove 25 and spray hole 21, with hole inlet section 22, hole inlet opening 221, hole outlet section 23, and hole outlet opening 231, are shown in section from above. Spray holes 21 and groove 25 are realized directly during the production of valve seat element 16, using an MIM (metal injection molding) process.

1-8. (canceled)

9. An injection valve for an internal combustion engine, comprising:
a sealing seat formed by a valve seat;
a closing head of a valve member; and
a plurality of spray holes situated downstream from the sealing seat, each spray hole including:
at least one upstream hole inlet section including a very small hole cross-section and a hole inlet opening, and
a downstream hole outlet section including a very large hole cross-section and a hole outlet opening, wherein the hole outlet sections are connected to one another via a groove having a groove opening that points downstream.

10. The injection valve as recited in claim 9, wherein a width of the groove is smaller than a hole diameter of the hole outlet openings.

11. The injection valve as recited in claim 9, further comprising:
a valve seat element that terminates in a valve chamber in a downstream direction in such a way that the valve seat is fashioned concentrically to an axis of the valve seat element on an inner wall, limiting the valve chamber, of the valve seat element, wherein:
the valve seat, the spray holes, and the groove are situated in the valve seat element, and
the hole inlet openings of the hole inlet sections are situated in a zone of the inner wall,
the inner wall is enclosed by the valve seat, and
the hole outlet openings of the hole outlet sections are situated in an outer wall, facing away from the valve chamber, of the valve seat element.

12. The injection valve as recited in claim 11, wherein the hole inlet openings of all hole inlet sections of the spray holes are situated in a trough-shaped recess that is fashioned in a zone enclosed by the valve seat of the inner wall of the valve seat element.

13. The injection valve as recited in claim 11, wherein:
the hole outlet openings of all hole outlet sections of the spray holes are situated on a divider circle that is concentric to the axis of the valve seat element, and
the groove is made with a circular annular shape.

14. The injection valve as recited in claim 11, wherein the spray holes are oriented in the valve seat element in such a way that hole axes of the spray holes are inclined at an acute angle to the axis of the valve seat element.

15. The injection valve as recited in 11, further comprising:
a valve seat bearer to which the valve seat element is fastened in a fluid-tight fashion, wherein:
the valve member is situated in the valve seat bearer so as to be capable of axial displacement, and
the valve member is capable of being actuated by an actuator.

16. The injection valve as recited in claim 11, wherein the valve seat element is produced by metal injection molding.
